(19) United States
(12) Patent Application Publication
(10) Pub. No.: US 2005/0182665 A1
(43) Pub. Date: Aug. 18, 2005

(54) Method of recruiting patients for a clinical study

(76) Inventors: Klaus Abraham-Fuchs, Erlangen (DE); Gudrun Zahlmann, Neumarkt (DE); Eva Rumpel, Erlangen (DE); Siegfried Schneider, Erlangen (DE); Markus Schmidt, Nuernberg (DE); Horst Schreiner, Fuerth (DE)

Correspondence Address: HARNESS, DICKEY & PIERCE, P.L.C., P.O.BOX 8910, RESTON, VA, 20195, US

(21) Appl. No.: 10/975,059

(22) Filed: Oct. 28, 2004

Related U.S. Application Data
(60) Provisional application No. 60/545,169, filed on Feb. 18, 2004.

(51) Int. Cl. G06F 17/60

(52) U.S. Cl. 705/3

(57) ABSTRACT

A method, apparatus and automated terminal are proposed for recruiting patients for at least one clinical study. The method includes screening for suitable clinical study patients in at least one public place, including obtaining information regarding potential patients for entry into a computer device. The method further includes determining, from information entered into the computer device, whether or not the potential patients qualify for at least one clinical study.

The present application hereby claims priority under 35 U.S.C. §119 on U.S. provisional patent application No. 60/545,169 filed Feb. 18, 2004, the entire contents of which are hereby incorporated herein by reference.

### FIELD OF THE INVENTION

The present invention is generally related to the field of clinical studies.

### BACKGROUND OF THE INVENTION

The framework for traditional business models for clinical studies has been rather stable over the last few decades. In such a business model, a sponsor (such as a pharmaceutical company which has developed a new drug, for example) paid all participants which performed in the study. At a minimum, these included participating patients and a medical doctor (an investigator) in charge of supervising the patients. In many cases, an investigation or clinical trial site (e.g., a hospital) was additionally included, where one or more investigators was employed.

So called contract research organizations (CROs) further established their services in the workflow chain of clinical studies, in between the sponsor on one end, and the investigator and patients on the other. The CRO often took over the complete management of the clinical study, including all necessary services including, for example, development of study protocol, recruiting patients and investigators and/or investigation sites, contracting the participants, supervising the conductance of the study, collecting and evaluating data, channeling the payment from the sponsor to the participants, etc. Of course, for such services, the CRO received a substantial part of the aforementioned payment for their own services.

When recruiting the patients, the CRO, or even the sponsor, tended to use and still uses crude methods wherein prospective patients fill out forms and are screened as candidates for clinical studies. The data utilized is normally that obtained from the patient himself or herself. Regarding the investigator or investigator/clinical trial site chosen to conduct/monitor/etc. the study, information previously obtained by the sponsor or CRO can be used. However, this is often a slow process which often does not produce an ideal patient, investigator or investigator/clinical trial site.

FIG. 1 illustrates a typical traditional cash flow system for use in connection with clinical studies. Initially, a sponsor 100 (such as a drug manufacturer, for example) defines the study requirements or criteria (study parameters, study protocol, etc.) for the particular clinical study in question. A CRO 120 may then be employed to manage the study, noting that the CRO 120 may develop the study requirements or criteria of the clinical study or may assist therein. The CRO may also assist in recruiting patients for the study, as well as selecting an appropriate investigator/investigators and appropriate clinical trial site(s). If a CRO is involved, the CRO is paid by the sponsor 100. The CRO then manages the study and then pays others involved in the study including investigators 130, patients 140, and potentially investigation or clinical trial sites such as hospitals, for example (not shown).

The recruitment of eligible volunteers or patients represents an essential and the most crucial step when performing a clinical trial. The identification of suitable patients is typically based on a set of inclusion and exclusion criteria. Today, patients get identified by either by their physician or by patients signing up on their own initiative, e.g. by an Internet portal. Both procedures display some limitations.

Recruiting the patients by their physician addresses in a competent manner typically results in a large number of patients who suffer from the disease in focus. However, these patients are typically already in medical treatment, which may represent an exclusion criteria for a clinical trial because of the risk or an interaction between the previously prescribed drugs and a drug to be tested.

Addressing the patients directly via advertising or Internet may reach out to a large number of individuals. However, as at the first step, the individuals are asked to name their disease and conditions, the quality of the data returned has typically been comparably low. Therefore a high effort has to be applied to select the eligible patient from a large number of applications.

It was, and still is, often difficult to recruit potential patients or volunteers for a clinical study. Further, it was and still is difficult to recruit potential patients or volunteers for the right study, especially in an efficient manner. Although some people might have volunteered for one study and might have even been eager to participate, often times they were not properly suited for that study.

### SUMMARY OF THE INVENTION

The present inventors have recognized problems with the traditional clinical study model. They have recognized that what is missing is a procedure, which reaches a large number of patients—and even asymptomatic patients—and still has a basis on valid data which helps to identify the suitable candidates at a very early phase of the enrollment process.

Thus, an object of an embodiment of the present application is to improve on the traditional clinical study model, and thus improve the recruitment of potential patients or volunteers for a clinical study. Specifically, the present inventors have recognized a need to obtain more qualified potential patients or volunteers for a clinical study and/or to match potential patients or volunteers to multiple studies. In an effort to solve such a need, one specific object of at least one embodiment involves improving at least one of the quality of the potential patients or volunteers recruited for a clinical study, and the quantity of potential patients or volunteers for a clinical study that desire to participate.

In one embodiment, this can include for example, a method of recruiting patients for at least one clinical study, comprising: screening for suitable clinical study patients in at least one public place, including obtaining information regarding potential patients for entry into a computer device; and determining, from information entered into the computer device, whether or not the potential patients qualify for at least one clinical study. The method may further include requesting a plurality of the potential patients, upon determining that they qualify for at least one study, to participate in at least one clinical study. The at least one public place may include for example, but is not limited to an airport or a mall. Further, the screening may include obtaining a sample of a bodily fluid from the potential patients or volunteers. Still further, information regarding the sample may be input into the computer device.

Further, in another embodiment, an apparatus is for recruiting patients for at least one clinical study. The apparatus comprises means for screening for suitable clinical study patients in at least one public place, including means for obtaining information regarding potential patients; and means for determining, from the obtained information, whether or not the potential patients qualify for at least one clinical study. The apparatus may further include means for requesting the potential patients, upon determining that they qualify for at least one study, to participate in at least one clinical study. Further, the at least one public place may include, for example, but is not limited to an airport or a mall. Further, the means for screening may include a means for obtaining a sample of a bodily fluid from the potential patients. In addition, information regarding the sample may be input into the means for determining.

In yet another embodiment, a brokering method for recruiting patients, in at least one public place, for at least one clinical study, has been developed. The method includes obtaining information relating to potential patients from a computer device located in the at least one public place; receiving criteria for a plurality of clinical studies; and determining, from the obtained information and from the criteria, matches between the potential patients and the clinical studies. Further, the criteria may be received from a database via at least one of a networked, wired and wireless connection. The method may further include requesting a plurality of the potential patients, upon determining that they qualify for at least one study, to participate in at least one clinical study.

Further, in another embodiment, an automated terminal can be provided for recruiting patients in at least one public place for at least one clinical study. The terminal may include at least one input device for obtaining information from potential patients in a public place; at least one device for at least one of storing and receiving criteria for at least one clinical study; and a device for determining, from the obtained information and from the criteria, whether or not the potential patients qualify for at least one clinical study. Further, the automated terminal may include a device for requesting a potential patient, upon determining that the potential patient qualifies for at least one study, to participate in at least one clinical study.

Other embodiments of the present application may include devices/systems for implementing any of the aforementioned methods, programs adapted to perform any of the aforementioned methods when executed on a computer device, and/or computer readable mediums storing any of the aforementioned programs.

For a full understanding of the nature and advantages of the various aspects of the invention, reference should be made to the detailed description of exemplary embodiments taken in conjunction with the accompany drawings. The detailed description provides only exemplary embodiments of the invention and thus, the claims of the present invention should not be limited as such.

### BRIEF DESCRIPTION OF THE DRAWINGS

The present invention will become more fully understood from the detailed description of preferred exemplary embodiments given hereinbelow and the accompanying drawings, which are given by way of illustration only and are thus not limitative of the present invention, and wherein:

FIG. 1 illustrates a typical traditional model for use in clinical studies;

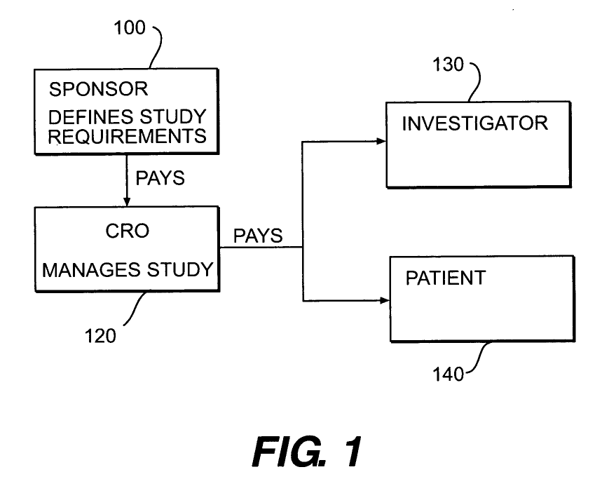

FIG. 2 is an example of the present application illustrating the methodology of one embodiment;

FIG. 3 includes an exemplary embodiment of a terminal 300; and

FIG. 4 is an example of the present application illustrating the methodology of another brokering embodiment.

### DETAILED DESCRIPTION OF THE EXEMPLARY EMBODIMENTS OF THE PRESENT APPLICATION

In one embodiment, the present invention is directed to an improvement on the traditional clinical study model, and thus an improvement of the clinical study recruitment process. Specifically, in one embodiment, the present invention is directed to a method of recruiting patients for at least one clinical study. The method includes screening for suitable clinical study patients in at least one public place, including obtaining information regarding potential patients for entry into a computer device. The method then includes determining, from information entered into the computer device, whether or not the potential patients qualify for at least one clinical study. The method may further include requesting a plurality of the potential patients, upon determining that they qualify for at least one study, to participate in at least one clinical study. The at least one public place may include for example, but is not limited to an airport or a mall. Further, the screening may include obtaining a sample of a bodily fluid from the potential patients or volunteers. Still further, information regarding the sample may be input into the computer device. As such, a large number of potential patients or volunteers can hopefully be obtained and can hopefully be properly associated with an appropriate clinical study.

In order to address a large number of people, public places like malls, airports etc. are especially suitable. Airports represent a special opportunity for screening for volunteers/patients as at large airports, a clinic may be provided for travelers waiting for connecting flights and who have some spare time. The combination of suitable medical devices and qualified personnel at a highly frequented site like a public place, will allow detection and identification of eligible clinical study patients in a fast and reliable way.

This procedure may be especially appropriate if at least one of the following occur:
the inclusion criteria can be detected by an economic procedure (point of care) or the planned study has a geographic focus;
synergy effects can be used as one, and the same parameter detected may serve the inclusion and exclusion criteria of a plurality of studies;
a broker may be used to represent several sponsors and therefore further may increase the synergistic effects; and
a broker may provide standardization of measurements, quality assurance and logistics for a large number of sites.

If the detected parameters qualify a passer-by for one or several studies, the person ma be informed of this. If the person consents, the next activities may be started. Preferably, the study sponsor only gets informed about the new participant after the informed consent of the volunteer/patient has been obtained.

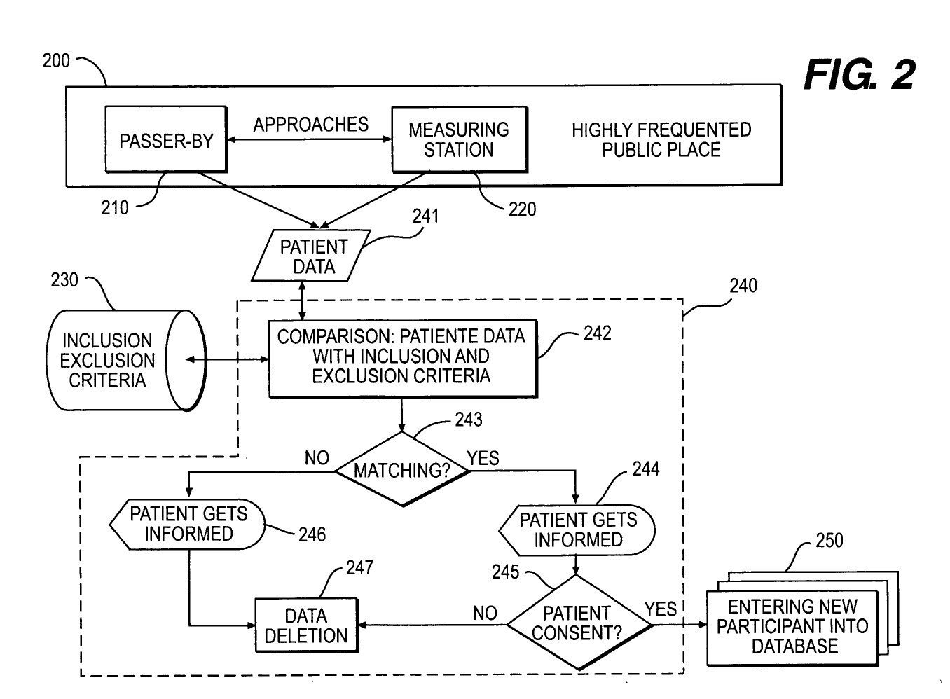

As indicated in FIG. 2, screening for suitable clinical study patients is done in at least one public place 200, which is preferably a highly frequented public place including for example, but not limited to an airport or a mall. Such a public place provides a plethora of potential patients or volunteers. Such potential patients or volunteers are designated by passer-by 210. From these potential patients or volunteers, if they are interested in volunteering for a clinical study, information can be obtained from them at measuring station 220. The measuring station 220 merely designates some area, preferably including a computer device, wherein information regarding potential patients can be obtained for entry into a computer device (including but not limited to patient data 241).

Then, from information entered into the computer device, a comparison 242 to inclusion and/or exclusion criteria regarding one or more clinical studies can be made, to determine whether or not the potential patients qualify for at least one clinical study. The inclusion and/or exclusion criteria regarding one or more clinical studies can be received by the computer device from one or more databases or storage devices 230 as shown in FIG. 2. Thereafter, a match is searched for in 243 and if a match is found (for example, if it is determined that a potential patient or volunteer qualifies for at least one clinical study), then the potential patient or volunteer may be informed or contacted in 244 to request participation in at least one clinical study. Thereafter, in 245, the patient may consent to participate in at least one clinical study and thus information relating to the patient may then be stored in a database 250, sent to those conducting the study, etc.

If a match is not found (for example, if it is determined that a potential patient or volunteer does not qualify for at least one clinical study), then the potential patient or volunteer may be informed of this or contacted in 246. Further, the obtained patient data may then be deleted in 247. Also, if the patient does not consent to participate in at least one clinical study in 245, then the obtained patient data may also be deleted in 247.

The inclusion/exclusion criteria 230 for performing in and/or complying with aspects of the study may be obtained from a clinical study sponsor and/or the CRO and/or directly from a clinical study SOP database (including clinical study “standard operating procedure” (SOP) information stored in at least one database). Additionally, although this information is not necessary, previously stored patient data for at least one study may be obtained from existing clinical IT infrastructure including, but not limited to any of the clinical workflow management system, electronic patient records (EPR), hospital information systems (HIS), or any other type of clinical IT infrastructure and/or database. The collected data may be compared and used in the matching determination (if desired) using a computer device 242, including but not limited to a device including a processor for example.

As mention above, previously stored clinical data for a patient can be used as part of the determination to match a potential patient or volunteer to at least one clinical study. This previously stored clinical data can include, but is not limited to data stored in a database of existing clinical IT infrastructure, such as an electronic healthcare database, for example. This can include, but is not limited to at least one of a database with electronic patient records, a database of clinical workflow management system, information from a hospital IT system (financial or clinical), information from a laboratory or radiology information system, information from a picture archiving and communication system (PACS), information from a physician's IT system, for example, etc.

As shown in FIG. 2 of the present application, element 242 may correspond to, but is not limited to, an analytical device. This analytical device can be a type of computer device/processor and/or server which may be networked or otherwise has access to patient data 241 and which may be further networked to, or can otherwise receive criteria regarding at least one clinical study (including but not limited to inclusion and/or exclusion criteria). Thus, although a potential patient or volunteer may visit the highly frequented public place 200 and see a sign or otherwise attempt to participate in one clinical study, his “patient data” can be compared to criteria of any number of clinical studies to determine a potential match. As such, potential patients and clinical studies can be more accurately matched.

Further, the patient data can include, but is not limited to patient identification information (e.g. patients name and birthday, or a patient identification code such as a patient social security number), clinical study related questionnaire information, etc., wherefrom a Patient's ID Database may be built as 250.

The analytical device 242 may further derive rules from the clinical study criteria. These rules may include, but are not limited to, rules which may be applied to check results/data from a patient for their compliance/matching with the criteria. These rules may be converted (if necessary) by the analytical device 242 into a machine-readable form, which can then be interfaced to and understood by, for example, a clinical workflow management system. Then, the rules may be applied, for example, for all patients with Ids contained in the patient ID data base (corresponding to patients participating within the clinical study); may be applied to check results of previous actions involving these patients for there compliance with the criteria.

The analytical device is able to access and analyze clinical data, such as that stored in/sent from/gathered at any measuring station, and can further be networked to analyze previously stored clinical data of a patient in a clinical workflow management system, EPR, HIS (or any other type of clinical IT infrastructure and/or database). This analytical device 242 may be connected or otherwise networked to, and can thereby access/receive/obtain and then analyze previously stored clinical data of patients participating in a previous study from any of the clinical workflow management system, EPR, HIS (or any other type of clinical IT infrastructure and/or database). The analytical device 242 may further be networked or otherwise connected to the sponsor, a clinical study SOP database and/or the CRO (to receive the inclusion/exclusion data 230 for at least one clinical study). The analytical device 242 can then receive or otherwise obtain criteria for a clinical study from the sponsor, clinical study SOP database and/or CRO and can then analyze the obtained patient data 241 in conjunction with (or based upon) the obtained criteria for at least one clinical study.

“Criteria”, as referenced throughout the embodiments of the application, refers to clinical study criteria, including but not limited to patient inclusion or exclusion criteria. Traditionally inclusion criteria contain patient data including but not limited to age, sex, kind of disease, etc. Some examples of frequently found exclusion criteria include but are not limited to illiteracy, lack of language knowledge, history of drug abuse, etc. These “criteria” are important aspects of the clinical study. These criteria of the study can be used by the analytical device 242. Thus, the criteria outline key or other important aspects of the clinical study which, when provided and correlated/compared with patient data, can help determine whether or not a patient is a good/ideal candidate to participate in a clinical study. To identify the ideal candidates, the inclusion of life-style data will provide additional benefit. For example, the fact whether or not a candidate has a driver license may indicate, or may at least correlate to whether or not the patient is likely to show up for regular appointments and check-ups.

Some non-limiting examples of inclusion/exclusion “criteria” include, but are not limited to:
Patient inclusion criteria or medical inclusion criteria such as, for example, patients with a given diagnosis (e.g., diabetes type I, for example). Another example of patient inclusion criteria can be, for example, age group (e.g., 40-60 years) of patients to be included in the study;
Patient exclusion criteria: Patients not previously diagnosed with an ailment, (hypertension, for example). Another example of patient exclusion criteria can be, for example, patients having been prescribed with a given medication “x” previously; history of drug abuse, co-morbidities which seriously reduce the patient's life expectancy;
All non-medical criteria which give some information about the expected patient compliance during the trial;
   Illiteracy;
   frequency of traveling, especially out of country;
   distance to the next available study site (hospital or physician's office);
   etc.

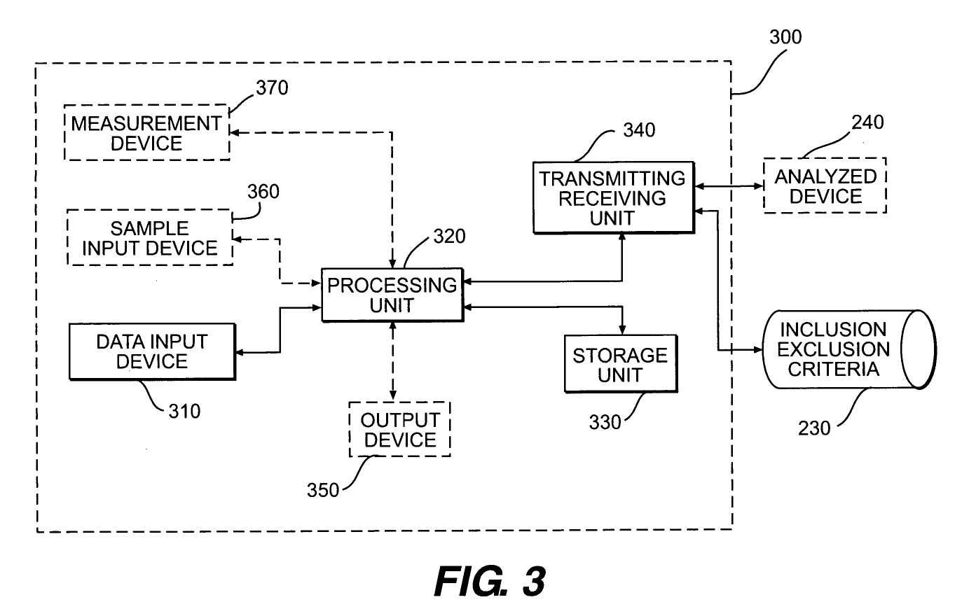

One non-limiting example of an embodiment of the present application is shown in FIG. 3. As shown in FIG. 3, an automated terminal 300 may be used at the public place, to collect information from the potential patient or volunteer (at or taking the place of measuring station 220 of FIG. 2). The automated terminal 300 may then store, output and/or send the patient information or collected patient data to analytical device 242; and/or may incorporate the functionality of analytical device 242 as a stand-alone unit itself. The automated terminal 300 may include, but is not limited to:
at least one data input device 310 including but not limited to e.g.
   key board
   touch screen
   microphone with voice recognition
   etc.;
data processing unit 320 (CPU);
data storage unit 330 (RAM, ROM, buffer, etc.);
data transmitting/receiving unit 340 (which may be connected via a network connection, modem, etc. to one or more of analytical device 240 and/or database 230;
one or more information output devices 350 (optional), including but not limited to e.g.
   Printer
   Fixed posters and inscriptions
   Monitor
   Ear-phones, loudspeaker
   Etc.
sample input device 360 (optional) for collecting and pre-processing samples like
   body fluids
   skin, hair samples
   etc.
one or more measurement devices 370 (optional) including but not limited to e.g.
   scales
   blood-pressure measurement device
   any kind of chemical, physical, biological measurement device handling above mentioned samples.

Thus, an automated terminal 300 can be provided for recruiting patients in at least one public place for at least one clinical study. The terminal 300 may include at least one input device for obtaining information from potential patients in a public place;

at least one device for at least one of storing and receiving criteria for at least one clinical study; and a device for determining, from the obtained information and from the criteria, whether or not the potential patients qualify for at least one clinical study. Further, the automated terminal may include a device for requesting a potential patient, upon determining that the potential patient qualifies for at least one study, to participate in at least one clinical study.

Through the placement of such measuring stations 220 and/or automated terminals 300 in public places including, but not limited to airports, malls, etc., potential patients and/or volunteers for clinical studies can be actively recruited in an efficient and in an at least partially automated manner. By the screening for suitable clinical study patients/volunteers in at least one public place, screening can be done in a mass scale fashion. As such, a large pool of potential patients/volunteers is made available. Further, as patient/volunteer information can be either directly or indirectly entered into a computer device, such information can then be compared against criteria for a plurality of clinical studies via analytical device 242. Accordingly, although a potential patient/volunteer may originally provide information in hopes of participating in one clinical study, he or she may further be accorded the possibility of participating in one or more additional clinical studies. As such, many more potential patients and/or volunteers will be recruited and will be able to be better matched for clinical studies to which they are best suited to participate.

Thus, during the screening for suitable clinical study patients in at least one public place, information and/or other bodily specimens may be obtained either through direct or indirect entry into a computer device. For example, information and/or other bodily specimens may be obtained and either simultaneously or subsequently entered from measuring station 220 into analytical device 242; and/or information and/or other bodily specimens may be more directly entered through an automated terminal 300 including obtaining information regarding potential patients for entry into a computer device.

The information and/or other bodily specimens to be obtained from potential clinical study patients/volunteers may include for example, but is not limited to: biographic data, which may include but not limited to age, sex, place of living, profession, etc.; data on life-style habits, which may include but not limited to smoking, drinking, extend of exercise, etc.; family history, which may include but not limited to diseases, deaths, etc.; clinical data a person might be able to tell, which may include but not limited to blood group, allergies, chronic diseases, etc.; clinical data that can be measured on-site, which may include but not limited to weight, blood-pressure, height, pulse, etc.; any data that may be acquired whether the person touches the terminal or not, which may include but not limited to optical methods surveying the seize and proportion of body parts, methods basing on spectroscopy, etc.; clinical data that can be measured on-site using body fluids, which may include but not limited to enzyme concentration, germs, metabolites, etc.; clinical data that can be measured on-site using skin, hair or other samples, which may include but not limited to germs, parasites, etc.; and etc.

Then, from information received by the computer device such as analytical device 242, whether or not the potential patients qualify for at least one clinical study may be determined. The method may further include requesting a plurality of the potential patients, upon determining that they qualify for at least one study, to participate in at least one clinical study. Further, the screening may include obtaining a sample of a bodily fluid from the potential patients or volunteers. Still further, information regarding the sample may be input into the computer device. As such, a large number of potential patients or volunteers can hopefully be obtained and can hopefully be properly associated with an appropriate clinical study.

The assignee of the present application has further been involved in various other inventions regarding clinical studies, and in some cases the use of clinical IT infrastructure, in order to improve the development of clinical study business models and/or the development of clinical study protocols; improving the effectiveness of patient recruiting; controlling the compliance of clinical study protocol rules; etc. The entire contents of each of the following applications is hereby incorporated by reference in the present application:
“Procedure to Identify Eligible Study Patients in an All-Day Setting” (U.S. provisional application Ser. No. 60/545,169, filed Feb. 18, 2004) and corresponding U.S. non-provisional application entitled “A Method Of Recruiting Patients For A Clinical Study”, assigned U.S. application Ser. No. ______, and filed on Oct. 28, 2004;
“Incentive-System for Clinical Trials” (U.S. provisional application Ser. No. 60/545,170, filed Feb. 18, 2004), and corresponding U.S. non-provisional application entitled “A Method Of Monitoring Patient Participation In A Clinical Study”, assigned U.S. application Ser. No. ______, and filed on Oct. 28, 2004;
“Procedure Providing a Benchmarking of Clinical Test Sites and a Concomitant Method of Quality-Based Monetary Compensation”; (U.S. provisional application Ser. No. 60/545,165, filed Feb. 18, 2004) and corresponding U.S. non-provisional application entitled “A Method Of Examining A Plurality Of Sites for A Clinical Trial”, assigned U.S. application Ser. No. ______, and filed on Oct. 28, 2004;
“Risk-Sharing Business Model for the Use of HIS Data to Improve Cost Effectiveness of Clinical Studies” (U.S. provisional application Ser. No. 60/545,168, filed Feb. 18, 2004) and corresponding U.S. non-provisional application entitled “A Method Of Improving A Clinical Study”, assigned U.S. application Ser. No. ______, and filed on Oct. 28, 2004;
“Quality Compliance Improvement in Clinical Studies using IT-Based Clinical Workflow Systems” (U.S. provisional application Ser. No. 60/545,164, filed Feb. 18, 2004) and corresponding U.S. non-provisional application entitled “Method and System For Measuring Quality of Performance and/or Compliance with Protocol of a Clinical Study”, assigned U.S. application Ser. No. ______, and filed on Oct. 28, 2004;
Verfahren zur Durchführung einer klinischen Studie (DE 10 2004 008 196.4);
Verfahren zur Überprüfung der Durchführbarkeit eines medizinischen Vorhabens mit Aufnahmekriterien für Patienten (DE 10 2004 008 189.1);
Verfahren zur Qualitätskontrolle von je an unterschiedlichen, aber vergleichbaren Patientenkollektiven im Rahmen eines medizinischen Vorhabens erhobenen medizinischen Datensätzen (DE 10 2004 008 197.2);
Verfahren und Einrichtung zur Überprüfung der Einhaltung einer Durchführungsvorschrift für eine an einem Patienten durchgeführte medizinische Maβnahme (DE 10 2004 008 190.5);
Verfahren zur Qualitätsbewertung von elektronisch gespeicherten, insbesondere medizinischen, Wissensdaten (DE 10 2004 008 191.3);
Verfahren zur Auswahl eines möglichen Teilnehmers für ein medizinisches Vorhaben anhand eines Auswahlkriteriums (DE 10 2004 008 192.1);
Verfahren und Informationssystem zur Durchführung einer klinischen Studie an einem Patienten. (DE 10 2004 008 194.8);
Verfahren zur Überprüfung der Einhaltung einer einem medizinischen Arbeitsablauf zugeordneten Durchführungsvorschrift (DE 10 2004 008 195.6); and
Verfahren zur Auswahl eines Teilnehmers für ein medizinisches Vorhaben mit Auswahlkriterien für Patienten (DE 10 2004 008 188.3).

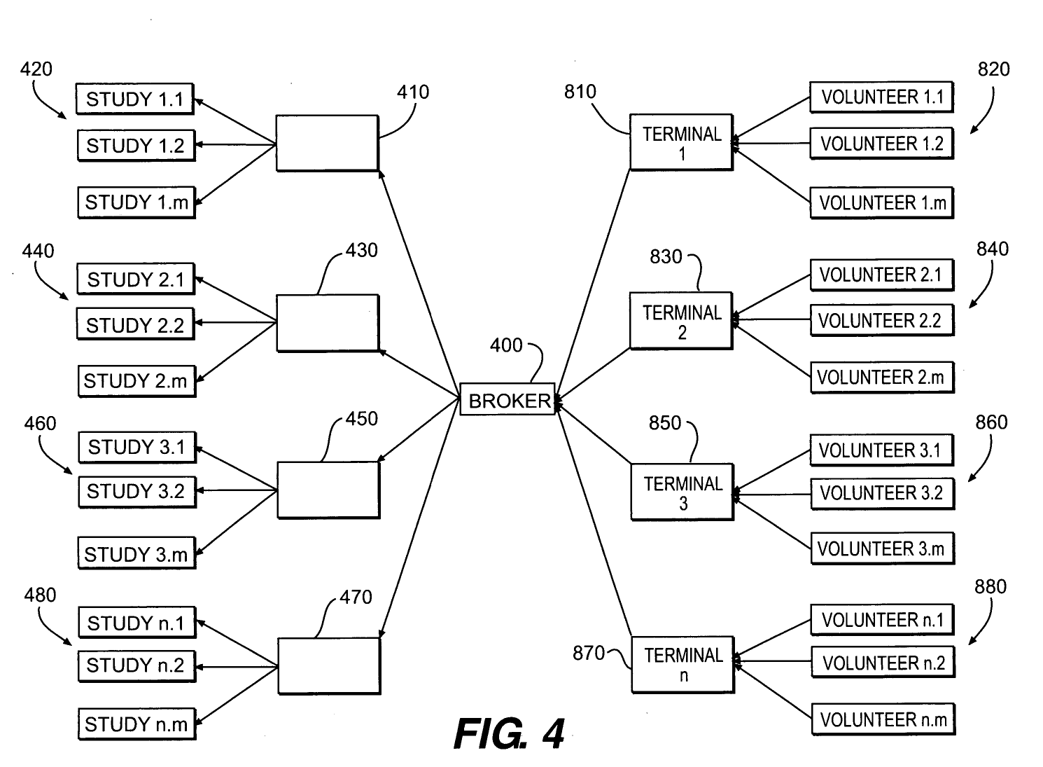

FIG. 4 lists another aspect of the present application. Here, a broker 400 is shown. The task of a broker 400 is performed efficiently if the broker manages to match a large number of volunteers to a large number of clinical studies. Thus, in such a situation, any of the aforementioned methods, systems, devices and apparatuses may be used as screening for potential patients/volunteers can take place in at least one public place; and matches to one or more clinical studies can occur.

The broker 400 may be faced with a variety of tasks and challenges. These can include for example, but are not limited to:
to attract study sponsors (pharmaceutical companies 410, 430, etc.; hospital(s) 450; governmental agency(ies) 470, etc.) and acquire contracts;
to identify crucial study inclusion/exclusion criteria 420, 440, 460, 480, etc. which can be obtained with an appropriate effort at public places;
to identify synergy effects;
to collect a comprehensive and complementary portfolio of studies to increase the likelihood that any volunteer matches at least one study; and/or
to identify suitable public places for automated terminals/measuring stations 810, 830, 850, 870, to address and recruit volunteers 820, 840, 860, 880.

Thus, in one embodiment a brokering method for recruiting patients, in at least one public place, for at least one clinical study, has been developed. The method includes obtaining information relating to potential patients from a computer device located in the at least one public place; receiving criteria for a plurality of clinical studies; and determining, from the obtained information and from the criteria, matches between the potential patients and the clinical studies. Further, the criteria may be received from a database via at least one of a networked, wired and wireless connection. The method may further include requesting a plurality of the potential patients, upon determining that they qualify for at least one study, to participate in at least one clinical study.

An especially effective realization of this concept may include, but is not limited to a broker who collects study protocols or just the inclusion and exclusion criteria of the protocols; and who delivers these protocols or criteria sets to recruiting stations located in public places like malls, supermarkets, airports, etc. In exchange the broker may get reimbursed either per patient identified, per protocol distributed, etc. The broker may transfer the data about patients who have agreed to participate to the study sponsor (this may include the transfer of documents like the signed informed consent or measurement results, etc.); translate the sponsor's inclusion and exclusion criteria into an assessment protocol for the local recruitment stations; design additionally (e.g. electronic) questionnaires to be used by the recruitment stations for patient assessment; and distribute the required equipment to the recruiting stations; and/or organize recruitment stations according to the franchising model.

Alternatively the recruiting stations may interact directly with the study sponsor and may receive from the sponsor, study protocols and inclusion/exclusion criteria, together with the assessment protocol and id required a pre-designed patient questionnaire; deliver the detected data together with the patient's informed consent form to the sponsor; and receive a reimbursement from the sponsor for each candidate recruited successfully. The assessment of patient data according to clinical standards at highly frequented public places allows a fast as well as reliable identification of persons or patients eligibly for a clinical study or other programs adhering to a protocol.

Additionally, for one or more of the various embodiments described above, additions or modifications may be made. For example, the determining may be based upon screening parameters of each at least one study, wherein such parameters may be part of the clinical study criteria and may be stored, for example, in database 230. In addition, it should be noted that database 230 is not limited to a single database. It may include one or more databases networked to analytical device 242. Further, one database, or a plurality of databases may include criteria for one or more clinical studies (i.e. the does not have to be a one-to-one correspondence between databases and clinical studies).

Besides the scenario clinical trials, such a procedure for one or more of the various embodiments described above for patient recruitment may be applicable to all cases where patient data have to be compared with protocol parameters in order to identify matching patients. This can include, but is not limited to:
identifying patients of a risk group (e.g. cancer) for preventive measures;
identifying patients eligible for treatment according to guideline A;
etc.

Still further, the parameters may be determined for each study prior to the screening, and may be stored, for example, in database 230. In addition, the screening parameters may be selectable (by analytical device 242 for example), wherein overlapping screening parameters may be selected for a plurality of clinical studies.

Even further, the determining in one or more of the embodiments, may be based upon protocol parameters of each at least one study, to identify matching potential patients. Such protocol parameters can be part of clinical study criteria of each at least one study, and can be stored in database 230. For example the prevalence of diabetes type II if the trial aims at testing a new anti-diabetic drug. Further, the determining may be based upon protocol parameters of each at least one study, to identify potential patients of a risk group for at least one preventative measure. For example, the prevalence of diabetes if the program aims at identifying high-risk patients for a retinopathy screening. Still further, the determining may be based upon protocol parameters of each at least one study, to identify potential patients eligible for a treatment. For example, a patient whose weight surpasses a specific threshold may qualify for a program offering a monitored dietary plan.

Additionally, in one or more of the embodiments, the method may further include requesting a plurality of the matching potential patients, upon determining that they qualify for at least one study, to participate in at least one clinical study. It may also include requesting a plurality of the identified potential patients, upon determining that they qualify for at least one study, to participate in at least one clinical study. Further, it may include requesting a plurality of the identified potential patients, upon determining that they qualify for at least one study, to participate in at least one clinical study. These steps of requesting may be done in any number of ways including, but not limited to electronically, via email for example, and/or in any other manner such as via post, for example.

An apparatus, in one embodiment, may further be designed for recruiting patients for at least one clinical study. Such an apparatus may include a device for screening for suitable clinical study patients in at least one public place, including a device for obtaining information regarding potential patients. This can include but is not limited to a computer device at measuring station 220 for example; an automated terminal 300 as shown in FIG. 3 for example, etc. The apparatus may further include a device for determining, from the obtained information, whether or not the potential patients qualify for at least one clinical study. This can include but is not limited to analytical device 242.

Further, it should be noted that the automated terminal 300 may further be equipped to perform the functions listed above, and the functions of analytical device 242 in that it may be networked, for example, to database 230 housing criteria for one or more clinical studies. The networking may be wired or wireless, via a modem connection for example. Thus, as shown in FIG. 3, the entire apparatus for recruiting patients for at least one clinical study may be an automated terminal 300. In addition, as automated terminal 300 may include an output device, whether it operates alone or in conjunction with analytical device 242, it may further act to request a matching potential patient, upon determining that he or she qualifies for at least one study, to participate in at least one clinical study. It may also include requesting an identified potential patient, upon determining that he or she qualifies for at least one study, to participate in at least one clinical study. Further, it may include requesting an identified potential patient, upon determining that he or she qualifies for at least one study, to participate in at least one clinical study. These steps of requesting may be done in any number of ways including, but not limited to electronically, via email for example, and/or in any other manner such as by outputting/printing the request.

One non-limiting example of an embodiment of the present application is as follows. First, the criteria of the clinical study indicates that potential patients/volunteers are need for studying the hereditary aspects of high-blood pressure in obese persons. These information can be stored in database 230 for example. Thereafter, at least one automated terminal 300 and/or measuring station 220 is set up in at least one public place. Thereafter:
a potential patient/volunteer approaches automated terminal 300 and/or measuring station 220;
a voice transmitted by loadspeakers (at least one output device 350 for example), for example, gives basic information and attracts attention;
on a monitor (at least one output device 350 for example), more detailed information regarding at least one clinical study is given;
the volunteer indicates his/her willingness to enter the procedure by touching the monitor screen (at least one data input device 310, noting that the data input and output devices may include an integrated input/output device);
the system, via monitor screen for example, inquires about the person's age, if the parents are alive and if the person has any children. The volunteer enters no/yes and the respective age if applicable via touch screen;
the system asks the volunteer to sit down and to put the arm into the measurement device (370 for example). A little video explains the procedure in detail;
The system detects the volunteers weight, blood-pressure and pulse rate (it them may transmit the information to analytical device 240 and/or it incorporates the functionality of analytical device 240 into processing unit 320 and thus, needs to merely temporarily store the detected information in storage unit 330 for example);
The system compares the data with the study requirements in the data base 230;
The system detects that the data are matching;
The system prints or otherwise outputs details about the matching study and potentially a phone number e.g. of a hospital, where the volunteer can be enrolled into the study; and
Volunteer leaves the automated terminal.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method of recruiting patients for at least one clinical study, comprising:
screening for suitable clinical study patients in at least one public place, including obtaining information regarding potential patients for entry into a computer device; and
determining, from information entered into the computer device, whether or not the potential patients qualify for at least one clinical study.

2. The method of claim 1, further comprising:
requesting a plurality of the potential patients, upon determining that they qualify for at least one study, to participate in at least one clinical study.

3. The method of claim 1, wherein the at least one public place includes an airport.

4. The method of claim 1, wherein the at least one public place includes a mall.

5. The method of claim 1, wherein the screening includes obtaining a sample of a bodily fluid from the potential patients or volunteers.

6. The method of claim 2, wherein the screening includes obtaining a sample of a bodily fluid from the potential patients or volunteers.

7. The method of claim 5, wherein information regarding the sample is input into the computer device.

8. The method of claim 6, wherein information regarding the sample is input into the computer device.

9. The method of claim 1, wherein the screening occurs at a plurality of public places within a geographic region.

10. The method of claim 2, wherein the requesting occurs at the at least one public place.

11. The method of claim 6, wherein the requesting occurs at the at least one public place.

12. The method of claim 1, wherein the determining is based upon screening parameters of each at least one study.

13. The method of claim 12, wherein the parameters are determined for each study prior to the screening.

14. The method of claim 12, wherein the screening parameters are selectable, and wherein overlapping screening parameters are selected for a plurality of clinical studies.

15. The method of claim 1, wherein the determining is based upon protocol parameters of each at least one study, to identify matching potential patients.

16. The method of claim 15, wherein the determining is based upon protocol parameters of each at least one study, to identify potential patients of a risk group for at least one preventative measure.

17. The method of claim 15, wherein the determining is based upon protocol parameters of each at least one study, to identify potential patients eligible for a treatment.

18. The method of claim 15, further comprising:
requesting at least one of the matching potential patients, upon determining that the at least one of the identified potential patient qualifies for at least one study, to participate in at least one clinical study.

19. The method of claim 16, further comprising:
requesting at least one of the identified potential patients, upon determining that the at least one of the identified potential patient qualifies for at least one study, to participate in at least one clinical study.

20. The method of claim 17, further comprising:
requesting at least one of the identified potential patients, upon determining that the at least one of the identified potential patient qualifies for at least one study, to participate in at least one clinical study.

21. The method of claim 1, wherein the determining takes place at the computer device.

22. The method of claim 1, wherein the determining takes place at a location remote from the computer device.

23. The method of claim 1, wherein the computer device is located at the at least one public place.

24. The method of claim 18, wherein the requesting takes place at the at least one public place.

25. The method of claim 19, wherein the requesting takes place at the at least one public place.

26. The method of claim 20, wherein the requesting takes place at the at least one public place.

27. A device for implementing the method of claim 1.

28. A device for implementing the method of claim 5.

29. A device for implementing the method of claim 6.

30. A device for implementing the method of claim 2.

31. A program, adapted to perform the method of claim 1, when executed on a computer.

32. A computer readable medium, storing the program of claim 31.

33. A program, adapted to perform the method of claim 2, when executed on a computer.

34. A computer readable medium, storing the program of claim 33.

35. A program, adapted to perform the method of claim 5, when executed on a computer.

36. A computer readable medium, storing the program of claim 35.

37. A program, adapted to perform the method of claim 6, when executed on a computer.

38. A computer readable medium, storing the program of claim 37.

39. An apparatus for recruiting patients for at least one clinical study, comprising:
means for screening for suitable clinical study patients in at least one public place, including means for obtaining information regarding potential patients; and
means for determining, from the obtained information, whether or not the potential patients qualify for at least one clinical study.

40. The apparatus of claim 39, further comprising:
means for requesting the potential patients, upon determining that they qualify for at least one study, to participate in at least one clinical study.

41. The apparatus of claim 39, wherein the at least one public place includes an airport.

42. The apparatus of claim 39, wherein the at least one public place includes a mall.

43. The apparatus of claim 39, wherein the means for screening includes a means for obtaining a sample of a bodily fluid from the potential patients.

44. The apparatus of claim 40, wherein the means for screening includes a means for obtaining a sample of a bodily fluid from the potential patients.

45. The apparatus of claim 43, wherein information regarding the sample is input into the means for determining.

46. The apparatus of claim 44, wherein information regarding the sample is input into the means for determining.

47. The apparatus of claim 39, wherein the screening occurs at a plurality of public places within a geographic region.

48. The apparatus of claim 39, wherein the determining is based upon screening parameters of each at least one study.

49. The apparatus of claim 48, wherein the parameters are determined for each study prior to the screening.

50. The apparatus of claim 48, wherein the screening parameters are selectable, and wherein overlapping screening parameters are selected for a plurality of clinical studies.

51. The apparatus of claim 39, wherein the determining is based upon screening parameters of each at least one study.

52. The apparatus of claim 51, wherein the parameters are determined for each study prior to the screening.

53. The apparatus of claim 51, wherein the screening parameters are selectable, and wherein overlapping screening parameters are selected for a plurality of clinical studies.

54. The apparatus of claim 39, wherein the determining is based upon protocol parameters of each at least one study, to identify matching potential patients.

55. The apparatus of claim 54, wherein the determining is based upon protocol parameters of each at least one study, to identify potential patients of a risk group for at least one preventative measure.

56. The apparatus of claim 54, wherein the determining is based upon protocol parameters of each at least one study, to identify potential patients eligible for a treatment.

57. The apparatus of claim 54, further comprising:
means for requesting a plurality of the matching potential patients, upon determining that they qualify for at least one study, to participate in at least one clinical study.

58. The apparatus of claim 55, further comprising:
means for requesting a plurality of the identified potential patients, upon determining that they qualify for at least one study, to participate in at least one clinical study.

59. The apparatus of claim 56, further comprising:
means for requesting a plurality of the identified potential patients, upon determining that they qualify for at least one study, to participate in at least one clinical study.

60. The apparatus of claim 39, wherein at least one protocol, common to each of a plurality of clinical studies, is used in the screening and determining.

61. The apparatus of claim 39, wherein at least one of inclusion and exclusion criteria of at least one protocol, common to each of a plurality of clinical studies, is used in the screening and determining.

62. The apparatus of claim 39, wherein at least one protocol, common to each of a plurality of clinical studies, is used in the screening and determining.

63. The apparatus of claim 39, wherein at least one of inclusion and exclusion criteria of at least one protocol, common to each of a plurality of clinical studies, is used in the screening and determining.

64. The apparatus of claim 39, wherein the determining takes place at the at least one public place.

65. The apparatus of claim 39, wherein the determining takes place at a location remote from the at least one public place.

66. The apparatus of claim 57, wherein the requesting takes place at the at least one public place.

67. The apparatus of claim 58, wherein the requesting takes place at the at least one public place.

68. The apparatus of claim 59, wherein the requesting takes place at the at least one public place.

69. An automated terminal for recruiting patients in at least one public place for at least one clinical study, comprising:
at least one input device for obtaining information from potential patients in a public place;
at least one device for at least one of storing and receiving criteria for at least one clinical study; and
a device for determining, from the obtained information and from the criteria, whether or not the potential patients qualify for at least one clinical study.

70. The automated terminal of claim 69, further comprising:
a device for requesting a potential patient, upon determining that the potential patient qualifies for at least one study, to participate in at least one clinical study.

71. The automated terminal of claim 69, wherein the at least one device for obtaining information includes a device for obtaining physical measurements from the potential patients.

72. The automated terminal of claim 69, wherein the wherein the at least one device for obtaining information includes a device for providing data input from the potential patients.

73. The automated terminal of claim 71, wherein the wherein the at least one device for obtaining information includes a device for providing data input from the potential patients.

74. The automated terminal of claim 71, wherein the at least one device for obtaining information includes a device for obtaining a sample of a bodily fluid from the potential patients.

75. The automated terminal of claim 69, wherein the determining is based upon screening parameters of at least one clinical study.

76. The automated terminal of claim 75, wherein the parameters are determined for each clinical study prior to the screening.

77. The automated terminal of claim 75, wherein the screening parameters are selectable, and wherein overlapping screening parameters are selected for a plurality of clinical studies.

78. The automated terminal of claim 76, wherein the screening parameters are selectable, and wherein overlapping screening parameters are selected for a plurality of clinical studies.

79. The automated terminal of claim 69, wherein the determining is based upon protocol parameters of each at least one study, to identify matching potential patients.

80. The automated terminal of claim 69, wherein the determining is based upon protocol parameters of each at least one study, to identify potential patients of a risk group for at least one preventative measure.

81. The automated terminal of claim 69, wherein the determining is based upon protocol parameters of each at least one study, to identify potential patients eligible for a treatment.

82. The automated terminal of claim 69, wherein at least one protocol, common to each of a plurality of clinical studies, is used in the determining.

83. The automated terminal of claim 69, wherein at least one of inclusion and exclusion criteria of at least one protocol, common to each of a plurality of clinical studies, is used in the determining.

84. A brokering method for recruiting patients, in at least one public place, for at least one clinical study, comprising:
obtaining information relating to potential patients from a computer device located in the at least one public place;
receiving criteria for a plurality of clinical studies; and
determining, from the obtained information and from the criteria, matches between the potential patients and the clinical studies.

85. The method of claim 84, wherein the criteria is received from a database via at least one of a networked, wired and wireless connection.

86. The method of claim 84, further comprising:
requesting a plurality of the potential patients, upon determining that they qualify for at least one study, to participate in at least one clinical study.

87. The method of claim 84, wherein the obtaining information includes obtaining a sample of a bodily fluid from the potential patients.

88. The method of claim 87, wherein information regarding the sample is input into the computer device.

89. The method of claim 84, wherein the information obtaining occurs at a plurality of public places within a geographic region.

90. The method of claim 84, wherein the determining is based upon screening parameters of each at least one clinical study.

91. The method of claim 90, wherein the parameters are determined for each clinical study prior to the screening.

92. The method of claim 91, wherein the screening parameters are selectable, and wherein overlapping screening parameters are selected for a plurality of clinical studies.

93. A device for implementing the method of claim 84.

94. A program, adapted to perform the method of claim 84, when executed on a computer device.

95. A computer readable medium, storing the program of claim 94.
